(19) United States
(12) Patent Application Publication
(10) Pub. No.: US 2013/0084560 A1
(43) Pub. Date: Apr. 4, 2013

(54) ANALYSIS OF A MICRONEUTRALIZATION ASSAY USING CURVE-FITTING CONSTRAINTS

(71) Applicants: Jarad Schiffer, Atlanta, GA (US); Kathy Hancock, Atlanta, GA (US)

(72) Inventors: Jarad Schiffer, Atlanta, GA (US); Kathy Hancock, Atlanta, GA (US)

(73) Assignee: The Government of the United States of America as by the Secretary of the Dept., of Health and Human, Atlanta, GA (US)

(21) Appl. No.: 13/700,978

(22) PCT Filed: Jun. 22, 2011
(86) PCT No.: PCT/US11/41459

§ 371 Date: Nov. 29, 2012

Related U.S. Application Data
(60) Provisional application No. 61/357,413, filed on Jun. 22, 2010.

(51) Int. Cl. G06F 19/10

(52) U.S. Cl. CPC G06F 19/10
USPC 435/5; 435/288.7; 702/19

(57) ABSTRACT

A method and apparatus are disclosed for analyzing a microneutralization assay. Specifically, an automated process can be used to read the optical density of multiple samples in a microneutralization assay and plot the results using one or more constraints. A particular constraint that can be used is a maximum optical density that is read from a sample. Using the plotted curve, a neutralization titer is determined, which is the highest dilution at which a virus is effectively blocked. Other constraints can also be used. For example, a constraint can be based on using a cell control optical density as a lower asymptote and a virus control optical density as an upper asymptote. When multiple constraints are used, analysis is performed to determine which constraint provided the most accurate curve fit.

### CROSS REFERENCE TO RELATED APPLICATION

This application claims the benefit of U.S. Provisional Application No. 61/357,413, filed on Jun. 22, 2010, which is incorporated herein by reference in its entirety.

### FIELD

The present disclosure relates to a method of analyzing microneutralization assays, and, more particularly, to analyzing microneutralization assays for the purposes of determining specific antibody concentrations and for optimizing a vaccine formulation.

### BACKGROUND

Microneutralization assays are used to determine how virus growth is reduced by neutralization with antibodies. Viral replication is often studied in the laboratory by infecting cells that are grown in plastic dishes or flasks, commonly called cell culture. As the virus replicates, infected cells detach from the cell culture plate resulting in visible changes called cytopathic effects. Another technique to visualize viral cell neutralization is through staining of the cells using a dye. Cells can be placed in small wells of a multi-well plate with some wells infected with a virus and others not. After an incubation period, the cells can be stained with dye, such as dye crystal violet that stains only living cells. They can also be stained with an antibody to the viral proteins that has a a detection tag such as a fluorescent dye or an enzyme that can cause a color change in a dye. This visual assay can be used to determine whether a serum sample contains antibodies that block virus infection. A serum sample is mixed with virus before infecting the cells. If the serum contains antibodies that block viral infection, then the cells will survive, as determined by staining with crystal violet or other methods such as measuring the optical density resulting from color change in a dye. If no antiviral antibodies are present in the serum, virus protein can be detected in the cells and the cells die.

To make the assay quantitative, two-fold dilutions of the serum are prepared and each is mixed with virus and used to infect cells. At the lower dilutions of serum, antibodies block infection, but at higher dilutions, there are too few antibodies to have an effect. The simple process of dilution provides a way to compare the virus-neutralizing abilities of different sera. The neutralization titer is expressed as the reciprocal of the highest serum dilution at which virus infection is blocked.

In order to optimize a vaccine, it is desirable to have a systematic way to analyze the titers. One way of determining the concentration of a substance in a sample is by performing serial dilution on the sample. Serial dilution techniques collect a finite number of data points for the sample by taking one or more observations (e.g., indicating optical density) of various dilutions (e.g., dilutions formed by adding various quantity of diluent to the sample). For example, dilutions of 10%, 1%, 0.1%, etc. can be measured for optical density. The results can then be used to determine a concentration of the substance in the sample via reference to a sigmoid curve representing serial-dilution observations for a sample having a known concentration of the substance (sometimes called a “standard” or “characteristic” sigmoid curve). The curve can be chosen so that the function f(x) calculates the optical density based on a particular dilution x. Given an optical density for a sample having an unknown concentration of the substance and the degree of dilution associated with the sample, the concentration of the substance can be back-calculated. In practice, plural observations of the optical density can be taken for plural degrees of dilution and applied to the standard curve.

Various techniques have been used to define the curve, analyze the observations, and calculate a concentration. One method is described by O'Connell, et al., “Calibration and assay development using the four-parameter logistic model,” Chemometrics and Intelligent Laboratory Systems, 20 (1993) 97-114, Elsevier Science Publishers B.V., Amsterdam (“O'Connell”). The O'Connell approach describes determining a minimum detectable concentration (MDC) and a reliable detection limit (RDL). The O'Connell technique can produce significant variability in its results. Another technique is described in U.S. Pat. No. 7,469,186 to Taylor, Jr., which is incorporated by reference. In that patent, variability of results are reduced, such as when testing for titers of antibodies or antigens via serial dilution.

Nonetheless, improved techniques are needed, particularly for data analysis of a microneutralization assay.

### SUMMARY

A method and apparatus are disclosed for analyzing a microneutralization assay. Specifically, an automated process can be used to read the optical density of multiple samples in a microneutralization assay. Based on the optical densities, a curve can be plotted that shows a change in optical density versus dilution. Using the curve, a neutralization titer can be determined, which is the highest serum dilution at which a virus is effectively blocked. The method and apparatus can be expanded beyond optical densities to any automated detection system for viral proteins, such as by using a fluorescent plate reader or other optical readers/imaging techniques.

In one embodiment, the optical densities are plotted using one or more constraints. A particular constraint that can be used is a maximum optical density of a sample. Generally, there are multiple samples on a plate and a median of the maximum optical densities for the samples can be used. The maximum optical density or the median of multiple optical densities can be used as an upper asymptote, while a lower asymptote can be a cell control optical density, in which no virus is added to the particular sample.

In another embodiment, other constraints can be used. For example, a constraint can be based on using the cell control optical density as a lower asymptote and a virus control optical density as an upper asymptote.

In yet another embodiment, where multiple constraints are used, analysis is performed to determine which constraint provided the most accurate curve fit. For example, a goodness of fit analysis can be used, and whichever constraint yielded the highest goodness of fit result can be selected as the optimal curve.

Once the curve fit is selected, a neutralization titer can be determined by using a midpoint between the virus control optical density and the cell control optical density. The intersection of that midpoint and the selected curve fit yields the serum neutralizing titer or antibody concentration.

The foregoing and other objects, features, and advantages of the invention will become more apparent from the following detailed description, which proceeds with reference to the accompanying figures.

### BRIEF DESCRIPTION OF THE DRAWINGS

FIG. 1 is an example flowchart of a method for analyzing a microneutralization assay using a curve fit with a constraint.

FIG. 2 is a flowchart of a method for determining the constraint of FIG. 1 that uses a maximum optical density.

FIG. 3 is a flowchart of a method for determining other constraints that can be used with the curve fit of FIG. 1.

FIG. 4 is a flowchart of a method for selecting one of multiple constrained curves.

FIG. 5 is an example plot with multiple curves having different constraints.

FIG. 6 is an apparatus that can be used for implementing the methods described herein.

FIGS. 7A and 7B show a detailed flowchart of analyzing a microneutralization assay in accordance with an embodiment.

### DETAILED DESCRIPTION

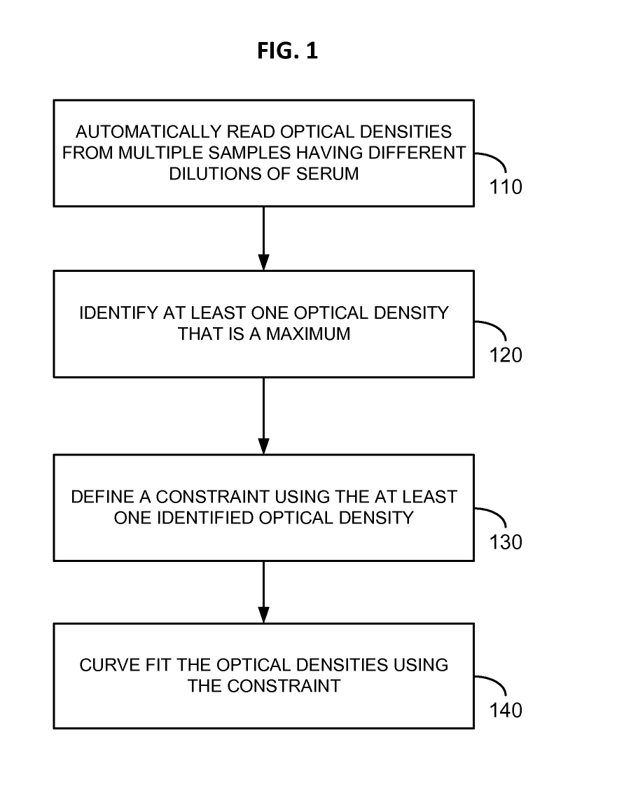

FIG. 1 is a flowchart of a method analyzing a microneutralization assay using constraints while curve fitting. Prior to performing an automated analysis on the microneutralization assay, samples are placed in wells of a multi-well (e.g., 96 wells) plate using varying dilutions of sera. A dye or an antibody is used to stain the cells, such as a dye crystal violet, which stains living cells so that it is possible to visually determine whether a serum samples contains antibodies that block virus infection. In process box 110, optical densities are automatically read. As further described below, optical densities can be read automatically using a spectrophotometer or other device that measures light intensity or light absorption. More specifically, the spectrophotometer reads the wells containing the samples by projecting a light beam into the well and measuring an amount of light absorption, which is related to a color of the well, and, consequently, is associated with the affect the serum has on a virus. The method and apparatus can also be expanded beyond optical densities to any automated detection system for viral proteins, such as by using a fluorescent plate reader or other optical readers/imaging techniques. In process block 120, a maximum optical density is identified for a sample. For multiple samples, a median of the maximum optical densities can be calculated. The maximum optical density is identified through a simple comparison with other optical densities obtained from the spectrophotometer and using the optical density with the highest value. In process block 130, a constraint is defined using the at least one identified optical density. For example, the constraint can use the maximum optical density or the median of the maximum optical densities as an upper asymptote. Notably, the constraint is based on a measured value of the samples. In process block 140, a curve fit is performed using the constraint. As described further below, in one embodiment a four-parameter logistic curve can be used with one or more constraints, wherein at least one constraint uses the maximum optical density as the upper asymptote. A lower asymptote can also be defined, such as using a cell control, as further described below.

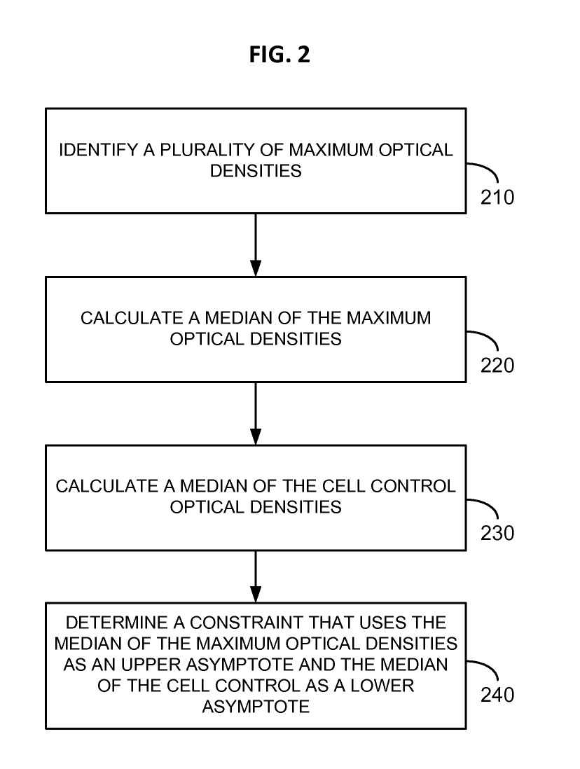

FIG. 2 is a flowchart of an embodiment that can be used to implement process blocks 120 and 130 in FIG. 1. In process block 210, a plurality of maximum optical densities are identified. Each sample on the plate has a maximum optical density that can be used. For each series of wells that make up the samples, a maximum optical density can be identified by obtaining the maximum number. In process block 220, a median of the maximum optical densities can then be calculated. In process block 230, a cell control optical density can be determined for each of the multiple samples and a median number calculated. The cell control represents a sample with no virus present. In process block 240, a constraint can then be determined by using the median of maximum optical density as an upper asymptote and the median of the cell control as a lower asymptote. A number of different constraints can be determined using the maximum optical density as the upper asymptote. For example, the maximum optical density can be the upper asymptote itself, or the upper asymptote can be defined as a range between the maximum optical density and the virus control optical density.

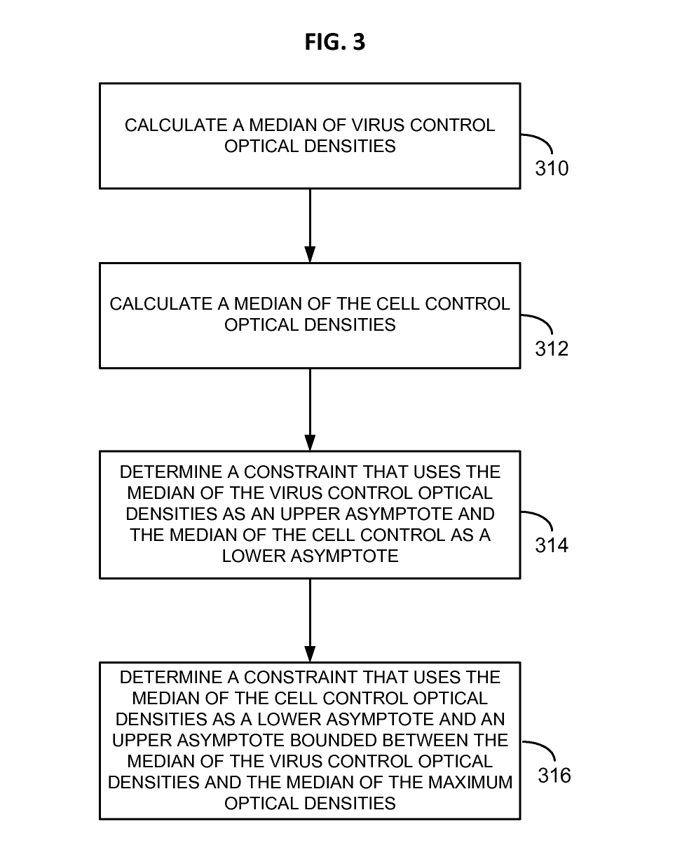

FIG. 3 is a flowchart of an embodiment where other constraints are determined. Using multiple constraints, different curve fits can be performed and a selection can be made of the best curve fit. In process block 310, multiple virus control optical densities are identified and a median of those optical densities is calculated. The virus control samples have virus added with no antibodies in the serum. This is theoretically considered to be a maximum amount of virus, but due to overloading cells with virus, does not always result in the maximum. In process block 312, a median of the cell control optical densities is calculated. In process block 314, a constraint is determined that uses the median of the virus control optical densities as an upper asymptote and the median of the cell control optical densities as the lower asymptote. In process block 316, another constraint can be determined that uses the median of the cell control optical densities as a lower asymptote and an upper asymptote is bounded between the median of the virus control optical densities and the median of the maximum optical densities.

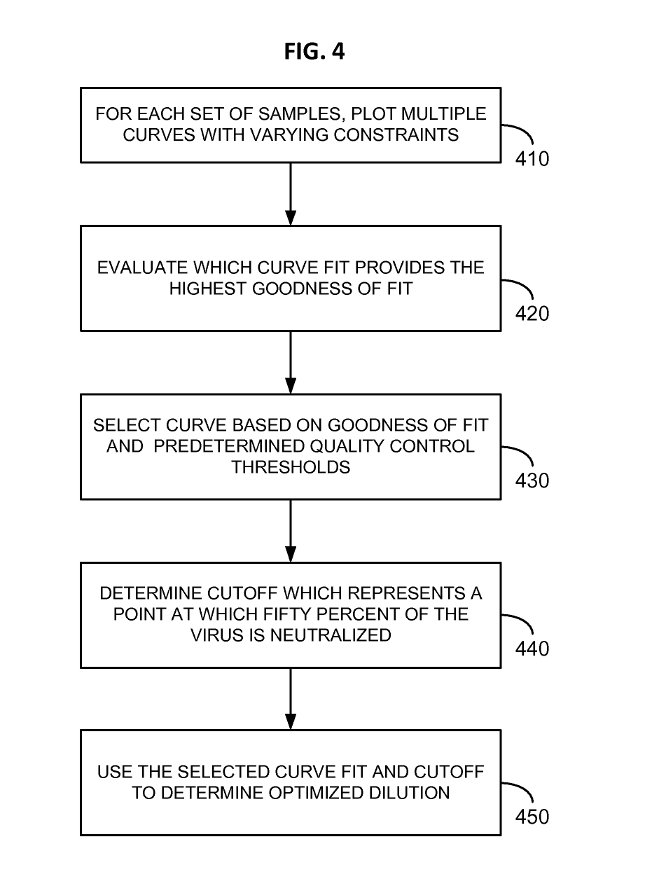

FIG. 4 is a flowchart of a method expanding on process box 140 (FIG. 1) according to one embodiment where multiple constraints are used. In process block 410, for each set of samples, multiple curves are plotted with varying constraints. For example, one curve is plotted for each constraint. In process block 420, an evaluation is performed to determine which curve fit provides the highest goodness of fit. The goodness of fit calculation provides a number for each curve plotted and that number can be compared to determine which curve scored the highest value. In process block 430, the curve with the highest goodness of fit is selected. However, the goodness of fit should satisfy some quality control thresholds. For example, the goodness of fit may have lower and/or upper thresholds (e.g., 0.85R²) and if it does not satisfy those thresholds, it is rejected. Curve slope is another factor that may be used for quality control. In process block 440, a cutoff is determined which represents a point at which fifty percent of the virus is neutralized. In one embodiment, the cutoff is a point midway between a maximum virus control line and a cell control line. Other cutoffs can potentially be used such as a midpoint between the measured maximum optical density and the cell control line, or between the upper and lower asymptotes of each curve fit. In process block 450, the optimized dilution can be determined using the intersection between the cutoff and the selected curve.

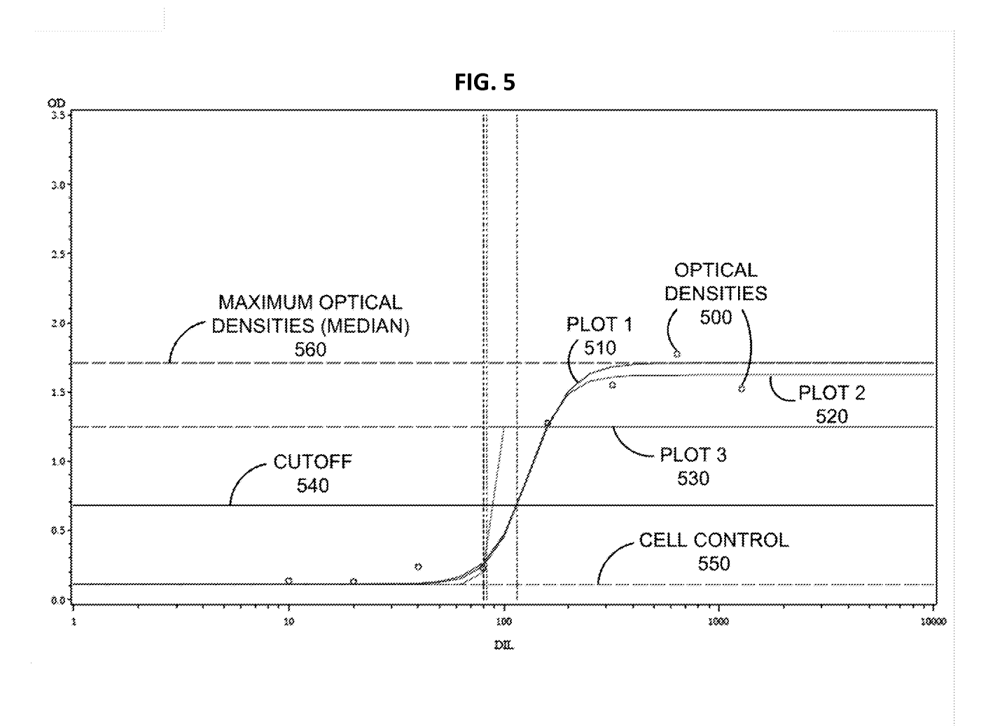

FIG. 5 shows examples of multiple curve fits using varying constraints. In this specific example, a series of optical densities (shown as dots, such as at 500) are plotted on an optical density versus dilution graph. A plot 510 using a first constraint uses a cell control 550 as a lower asymptote and the median of the maximum optical densities 560 as the upper asymptote. A plot 520 uses cell control as a lower asymptote and the upper asymptote is bounded between the virus control and the median maximum optical density. A plot 530 uses the virus control as the upper asymptote and cell control 550 as the lower asymptote. The different constraints yield different plots and it is desirable to select the optimal plot that provides the best results.

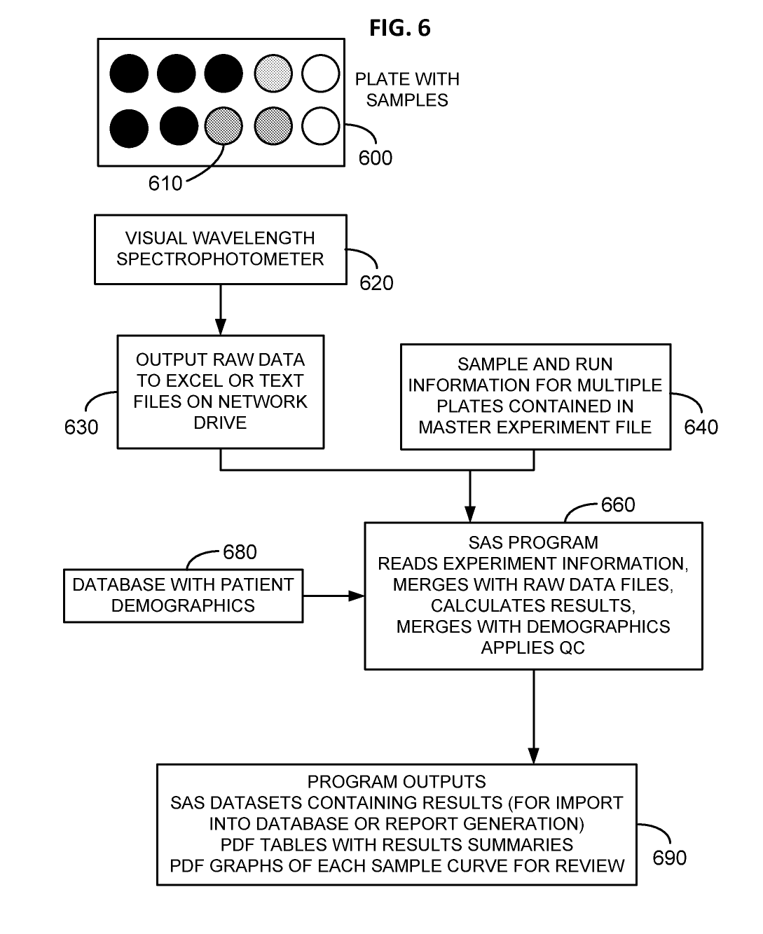

FIG. 6 shows an embodiment of an apparatus used to analyze a microneutralization assay. A plate 600 is shown having a plurality of wells, such as at 610. Typically, the number of wells can be more than shown, such as ninety-six wells, but only ten are illustrated for simplicity. The samples in the wells vary in color with darker wells having more living cells and whiter wells having more virus. A visual wavelength spectrophotometer 620 is placed adjacent the wells in order to read the optical densities of the wells. At 630, the spectrophotometer outputs raw optical density data to an Excel spreadsheet, text files, or other files to be stored on a network drive. The sample and run information 640 provides additional information associated with the raw data, such as patient information, starting dilutions, controls, well position, etc. Some spectrophotometers may allow inclusion of sample and run information in the same file as the raw data. The raw data 630 and sample and run information 640 are merged and read by a program 660 running on a client computer. The program 660 can also read a database 680 having stored thereon further patient information, such as patient demographics. The program 660 can be in any desired language, but in one embodiment it was programmed in SAS. At 690, output is provided that can be displayed or otherwise stored in memory or on a hard drive. It will be recognized by one skilled in the art, that the system can include a variety of network computers integrated together.

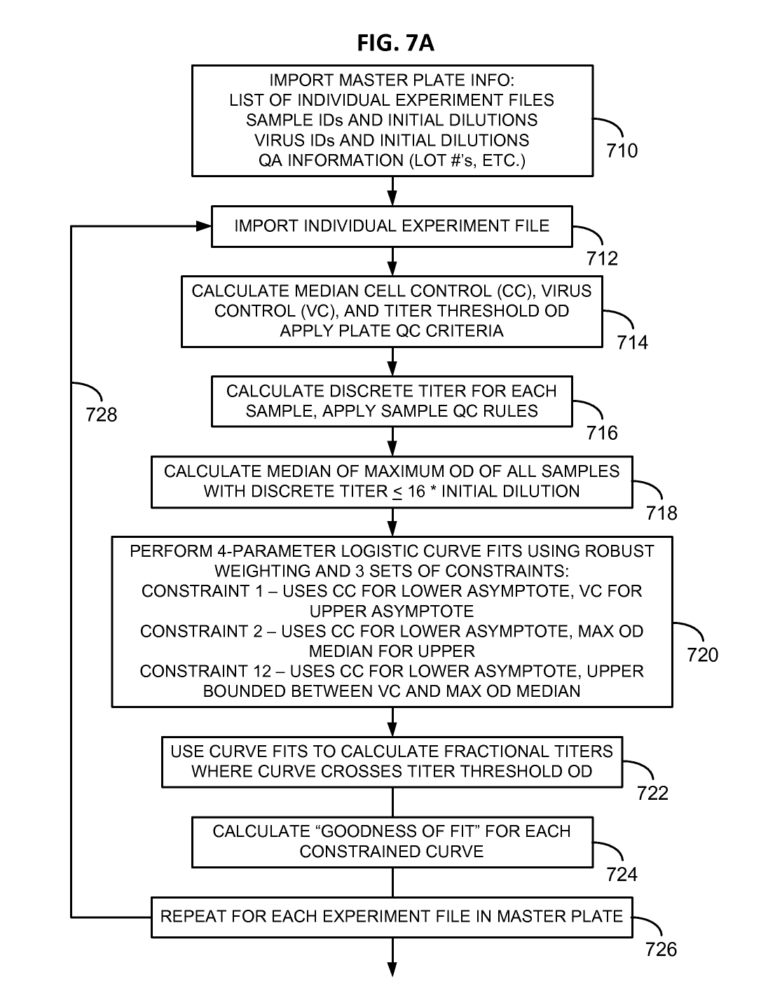

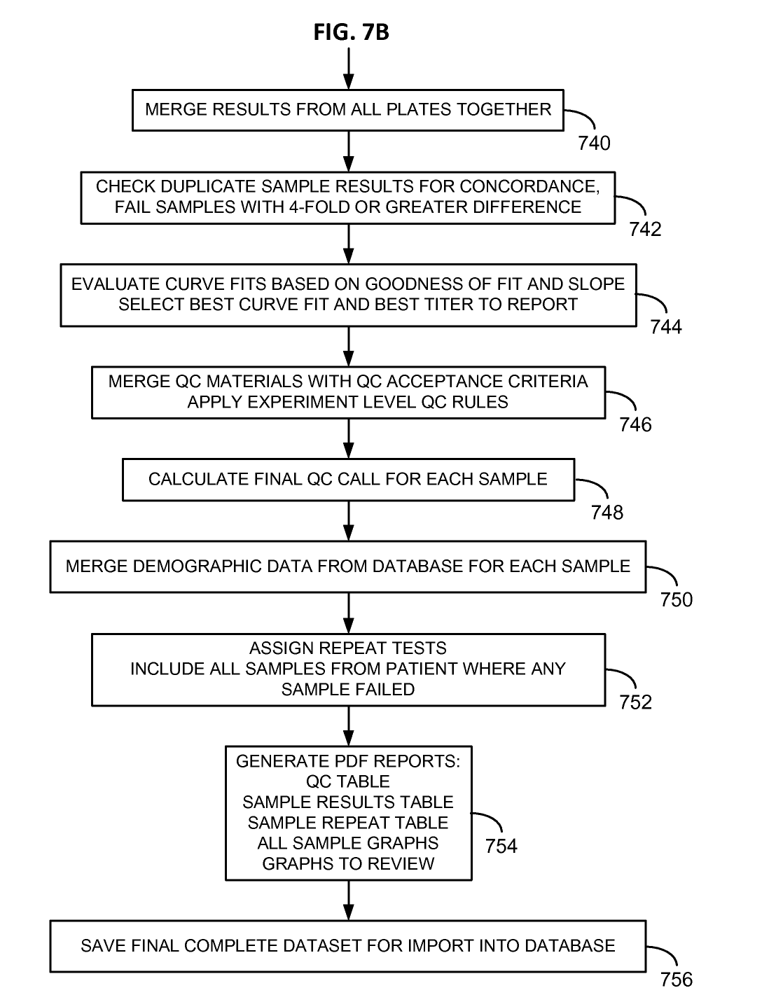

FIGS. 7A and 7B show an overall flow of an embodiment of the method for analyzing a microneutralization assay. In process block 710, information from one or more plates containing the samples is imported from the spectrophotometer or a database. The information can be any desired information based on the design, such as a list of individual experiment files, sample identifications and their associated initial dilutions, virus identifications and their associated initial dilutions, quality control information, etc. A first process block 712 is a start of a loop wherein each experiment file associated with a master plate is analyzed and data is plotted. Each file contains the data from a single assay plate. In process block 712, a first experimental data file is imported for analysis. In process block 714, initial parameters associated with the data file are determined. For example, a number of wells on the master plate are used for cell control wherein no virus is added or virus control wherein no serum is added. The optical densities of the cell control wells and virus control wells are identified and a median optical density is determined for each. A titer threshold is then calculated by determining a midpoint between a median of the cell control optical densities and a median of the virus control optical densities. Some initial quality control can also be performed, such as checking whether the median values are within acceptable ranges. In process block 716, a discrete titer is calculated for each sample. The discrete titer is determined by identifying a highest dilution that is just below the titer threshold value. Quality control rules can also be used to check this value to ensure it is within predetermined limits. In process block 718, an identification is made of the maximum optical densities of all samples, and a median is calculated for that number. It is preferable that only optical densities are used that reached their maximum. As a result, an initial check is made before calculating the median whether the optical density satisfies predetermined criteria for being a maximum. One such criteria is to check whether the samples reached threshold optical density calculated in 714 at a dilution that is less than or equal to 16 times their initial dilution. If the samples do not satisfy this criteria, then they are not used in the calculation of the median for the maximum optical densities.

In process block 720, a curve fit is performed. The preferable curve fit is a four parameter logistic curve fit using robust weighting and three sets of constraints. There are a number of techniques for robust curve fitting and weighting that can be used, such as Tukey's Bisquare, Andrew's Sine, German-McClure, Huber, Welsch, and Cauchy. The curve fitting can be an iterative fitting process wherein on each iteration, the fitting algorithm changes parameter values based on the data set provided in order to converge the best results. Individual weighting can be used so that weighting values for each data point are changed to enable the fit to converge. A data point that is an outlier can be down weighted to achieve a more robust and better fit for the remaining points in the data set. Constraints are further used to ensure beginning and end conditions are met. A first constraint uses the median cell control optical density as a lower asymptote and the median virus control optical density as an upper asymptote. A second constraint uses the median of the cell control as a lower asymptote and the medium of the maximum optical density calculated in process block 718 as an upper asymptote. A third constraint uses a median cell control as a lower asymptote and the upper asymptote is bounded between the median virus control and the median maximum optical density. Less constraints or different constraints can be used. For example, higher-order constraints, such as the change of rate of curvature can also be used. Alternatively, only the upper asymptote end constraints can be used. The desired constraints depend on the particular application.

In process block 722, the curve fits are used to calculate fractional titers where the curve crosses the titer threshold optical density. The crossing point indicates the neutralization titer, which is the dilution at which 50% of the virus infection is blocked. In process block 724, a goodness of fit is calculated for each constrained curve. The goodness of fit is a well-known statistical model used for curve fitting. In process block 726, a check is made whether files for the experiment have been completed and, if not, a loop is made to process block 712 as indicated by arrow 728. Once all of the curves are created for each experimental file in the master plate, the process continues to process block 740 (FIG. 7B). In process block 740, the results of all plates are merged together by reading them into a single program or storing them into a single file. In process block 742, another quality control feature can be used. In particular, duplicate samples on the plates can be used and a comparison can be made between the samples to ensure that they are reasonably close. If they are more than a two-fold difference, they are failed and not used. In process block 744, curve fits are evaluated based on goodness of fit and slope. The slope and the goodness of fit can be checked to determine whether they are within predetermined thresholds. For example, a minimum threshold for a goodness of fit can be 0.85R² or 0.90R². The slope can also be checked whether it is too steep or too shallow based on predetermined thresholds. Any curve that does not satisfy the predetermined thresholds is not used. If the predetermined thresholds are met, then the curve with the highest goodness of fit evaluation is used as the best curve. The best curve can be the curve plotted using any of the constraints used in process block 720 and the curves plotted with the other constraints are thrown out. In process block 746 another quality check can be performed. In particular, some samples on the plate have known results and these samples are checked against predetermined quality criteria to ensure they are consistent. If the samples do not meet the predetermined quality criteria then the overall results can be failed and the experiment re-preformed.

In process block 748, a final quality control check is performed to ensure that all quality control parameters have been passed. Checks were performed on the plate level and sample level and those checks are analyzed to ensure everything passed. In process block 750 the demographic data is merged for each sample. In process block 752, any samples that failed are assigned to be repeated so that the experiment can be re-performed for failed samples. In process block 754, reports are generated, such as the finalized curve fits and quality control tables. In process block 756, the final data is exported to a file or displayed on a screen.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions stored on one or more computer-readable storage media (e.g., non-transitory computer-readable media, such as one or more optical media discs, volatile memory components (such as DRAM or SRAM), or nonvolatile memory components (such as hard drives) and executed on a computer (e.g., any commercially available computer, including smart phones or other mobile devices that include computing hardware). Any of the computer-executable instructions for implementing the disclosed techniques as well as any data created and used during implementation of the disclosed embodiments can be stored on one or more computer-readable media (e.g., non-transitory computer-readable media). The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and subcombinations with one another. The disclosed methods, apparatus, and systems are not limited to any specific aspect or feature or combination thereof, nor do the disclosed embodiments require that any one or more specific advantages be present or problems be solved.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope of these claims.

We claim:

1. A method of analyzing a microneutralization assay, comprising:
automatically reading optical densities from a plurality of samples in the micronneutralization assay;
identifying at least one optical density that is at a maximum;
determining a constraint using the at least one identified maximum optical density; and
curve fitting the optical densities using the determined constraint.

2. The method of claim 1, wherein identifying the at least one optical density includes identifying a plurality of maximum optical densities and determining the constraint includes calculating a median of the plurality of maximum optical densities.

3. The method of claim 1, further including identifying a cell control optical density wherein no virus is present in a sample and identifying a virus control optical density wherein virus is added to a sample with no serum.

4. The method of claim 3, wherein the constraint is a first constraint, and further including determining a second constraint that uses the cell control optical density as a lower asymptote and the virus control optical density as an upper asymptote.

5. The method of claim 4, further including determining a third constraint that uses the cell control optical density as a lower asymptote and the maximum optical density as an upper asymptote.

6. The method of claim 3, wherein the constraint uses the cell control optical density as a lower asymptote and an upper asymptote bounded between the virus control optical density and maximum optical density.

7. The method of claim 1, wherein the constraint includes using a cell control optical density as a lower asymptote and the maximum optical density as an upper asymptote.

8. The method of claim 1, further including using multiple constraints and plotting multiple curves using the constraints and selecting one of the multiple curves using a goodness of fit evaluation.

9. A method of analyzing a microneutralization assay, which includes multiple samples including varying dilutions of serum, comprising:
automatically reading optical densities of the microneutralization assay;
for a plurality of samples that have no virus added, calculating a median cell control optical density;
for a plurality of samples that have no serum added, calculating a median virus control optical density;
calculating a median of maximum optical densities of the samples; and
perform multiple four-parameter logistic curve fits using different constraints, the constraints using one or more of the median cell control optical density, the median virus control optical density and the median of the maximum optical densities as asymptotes.

10. The method of claim 9, wherein the constraints include a first constraint that uses the median cell control optical density as a lower asymptote and the median virus control as an upper asymptote, a second constraint that uses the median cell control optical density as a lower asymptote and median of the maximum optical densities as an upper asymptote, and a third constraint that uses the median cell control optical density as a lower asymptote and an upper asymptote that is bounded between the median of the maximum optical densities and the median virus control.

11. The method of claim 9, further including calculating a goodness of fit for each constrained curve.

12. The method of claim 11, further including selecting one of the curve fits as being a best fit based on slope and goodness of fit.

13. The method of claim 9, further including calculating a discrete titer for each sample and only using maximum optical densities that have a discrete titer that is less than a predetermined threshold.

14. The method of claim 9, wherein reading the optical densities includes projecting light into the samples and determining an amount of light absorption.

15. The method of claim 9, further including comparing a slope of curves resulting from the curve fits and rejecting any curves that are not within predetermined limits.

16. The method of claim 9, wherein quality control is implemented on curves resulting from the curve fits by rejecting any curves that have a goodness of fit that are outside of predetermined limits.

17. The method of claim 9, further including selecting one of the curve fits based on a goodness of fit algorithm.

18. An apparatus for analyzing microneutralization assays, comprising:
an optical or imaging device for measuring viral proteins of multiple samples contained in wells of a plate;
a computer having instructions stored thereon for executing a method, comprising:
determining a measured value that is representative of a maximum of the measured values of viral proteins; and
curve fitting the measured values using a constraint having the determined maximum measured value as an upper bounded asymptote.

19. The apparatus of claim 18, further including database coupled to the computer, the database for storing patient demographic information.

20. The apparatus of claim 18, further including identifying a cell control optical density wherein no virus is present in a sample and using the cell control optical density a lower-bounded asymptote.

21. The apparatus of claim 18, further including outputting a final curve fit to a display or storage.

22. The apparatus of claim 18, wherein the optical or imaging device includes one of the following: a spectrophotometer or a fluorescent plate reader.
